(19) United States
(12) Patent Application Publication
(10) Pub. No.: US 2019/0273347 A1
(43) Pub. Date: Sep. 5, 2019

(54) Plated Modular Adapter

(71) Applicant: Optical Cable Corporation, Roanoke, VA (US)

(72) Inventors: Derrick F. Stikeleather, Black Mountain, NC (US); Sumio Seo, Wallingford, VT (US); James Yanik, Asheville, NC (US); Jamey O. Calloway, Weaverville, NC (US)

(73) Assignee: Optical Cable Corporation, Roanoke, VA (US)

(21) Appl. No.: 16/291,929

(22) Filed: Mar. 4, 2019

Related U.S. Application Data
(60) Provisional application No. 62/637,681, filed on Mar. 2, 2018.

(51) Int. Cl. H01R 31/06; H01R 13/50; H01R 13/6463

(52) U.S. Cl. CPC H01R 31/065; H01R 13/6463; H01R 13/50

(57) ABSTRACT

An electrically conductive assembly includes a connector; a rack mount panel including a plurality of integrally formed cutouts, the rack mount panel being formed from an electrically conductive material; an intermediate modular adapter that is sized and configured for selective engaged receipt within a corresponding one of the plurality of integrally formed cutouts; the intermediate modular adapter including a plurality of integrally formed openings each being sized for engaged receipt of the connector; the intermediate modular adapter being plated with an electrically conductive material; and wherein selective engagement of the connector in one of the plurality of integrally formed openings on the intermediate modular adapter creates an electrical connection between the connector, the rack mount panel, and the intermediate modular adapter.

### RELATED APPLICATION

This application claims priority to and incorporates entirely by reference U.S. Provisional Patent Application Ser. No. 62/637,681 filed on Mar. 2, 2018.

### FIELD OF INVENTION

This invention relates to modular adapters for mounting different styles of connectors and, more particularly, plated modular adapters.

### BACKGROUND OF THE INVENTION

RJ-45 style Ethernet connectivity is often mounted within a standard sized 19-inch wide rack by means of metal or plastic mounting panels. These panels are typically manufactured with cutouts to mount specific types of connectors, meaning that for particular types or styles, a different panel would be needed, requiring multiple part numbers.

In order to simplify and modularize the panel design, the cutouts can be made larger. Utilizing larger openings in the rack mount panel allows for connectors to be mounted in an intermediate modular adapter, which can be molded from inexpensive plastic compounds and sized for receipt in the larger openings of the rack mounted panel. For example, an intermediate modular adapter may be designed such that the outer portion has dimensions which allow it to fit within the larger panel openings, while the inner area or openings within could be made to fit different styles of connectors, such as a 6-port data module or some number of discreet KMJ style connectors.

While existing panel designs, as described above, are useful for their intended purpose, there remain problems. One such problem occurs when the product to be mounted within the plastic adapter has a shield element associated with it, such as a data outlet designed to connect shielded twisted-pair (STP) cables. Shield elements must be electrically connected to the rack or frame, which is bonded to the building ground structure. In a traditional situation wherein the panel is a completely metallic unit, this is easily achieved by strategic placement of unpainted surfaces to allow the shield element of the connector to be in intimate contact with the panel frame, thus completing the connection. When a modular plastic adapter is used, the situation becomes more complicated. One attempt at a solution is using metallic elements attached to the plastic adapter, wherein the metallic elements serve to bridge the gap between the connectors and the panel frame; however, this makes the part more complicated to produce and more expensive. In some instances, the metallic element is a separate part that must be placed by the installer after the connectors have been mounted. This is also not ideal due to associated expense.

Accordingly, there exists a need for an intermediate modular adapter, which, when a connector is inserted therein, the connector and the intermediate modular adapter are electrically connected into an assembly and further mitigates crosstalk between unshielded type connectors.

### SUMMARY OF THE INVENTION

In accordance with one form of this invention, there is provided electrically conductive assembly including a connector; a rack mount panel including a plurality of integrally formed cutouts, the rack mount panel being formed from an electrically conductive material; an intermediate modular adapter that is sized and configured for selective engaged receipt within a corresponding one of the plurality of integrally formed cutouts; the intermediate modular adapter including a plurality of integrally formed openings each being sized for engaged receipt of the connector; the intermediate modular adapter being plated with an electrically conductive material; and wherein selective engagement of the connector in one of the plurality of integrally formed openings on the intermediate modular adapter creates an electrical connection between the connector, the rack mount panel, and the intermediate modular adapter.

In accordance with another form of the present invention, there is provided an electrically conductive assembly for grounding a connector shield element to a rack mounted panel, the electrically conductive assembly including a connector including the connector shield element; the rack mount panel including a plurality of integrally formed cutouts, the rack mount panel being formed from an electrically conductive material; an intermediate modular adapter that is sized and configured for selective engaged receipt within a corresponding one of the plurality of integrally formed cutouts; the intermediate modular adapter including a plurality of integrally formed openings each being sized for engaged receipt of the connector; the intermediate modular adapter being plated with an electrically conductive material; and wherein selective engagement of the connector in one of the plurality of integrally formed openings on the intermediate modular adapter creates an electrical connection between the connector, the rack mount panel, and the intermediate modular adapter, thereby grounding the connector shield element.

In accordance with another form of the present invention, there is provided an electrically conductive assembly for grounding a connector shield element to a rack mounted panel, the electrically conductive assembly including a connector including the connector shield element; the rack mount panel including a plurality of integrally formed cutouts, the rack mount panel being formed from an electrically conductive material; an intermediate modular adapter being formed from plastic that is sized and configured for selective engaged receipt within a corresponding one of the plurality of integrally formed cutouts; the intermediate modular adapter including a plurality of integrally formed openings each being sized for engaged receipt of the connector; the intermediate modular adapter being plated with an electrically conductive material; and wherein selective engagement of the connector in one of the plurality of integrally formed openings on the intermediate modular adapter creates an electrical connection between the connector, the rack mount panel, and the intermediate modular adapter, thereby grounding the connector shield element.

### BRIEF DESCRIPTION OF THE DRAWINGS

For a fuller understanding of the nature of the present invention, reference should be made to the following detailed description, taken in conjunction with the accompanying drawings in which:

FIG. 1 is an exemplified illustration of a metal mounting panel with four cutouts;

FIGS. 2A-2C are a front view, rear view, and perspective view, respectively, of a plastic intermediate modular adapter;

FIG. 3 is a perspective view illustrating the plastic plated modular adapter of the present invention and including connector secured thereto; and

FIG. 4 is an isolated perspective view of the plastic plated modular adapter assembled to a metal panel frame.

Like reference numerals refer to like parts throughout the several views of the drawings.

### DETAILED DESCRIPTION OF THE PREFERRED EMBODIMENTS

Referring to the several views of the drawings, the plated plastic intermediate modular adapter for mounting panels is shown and described herein.

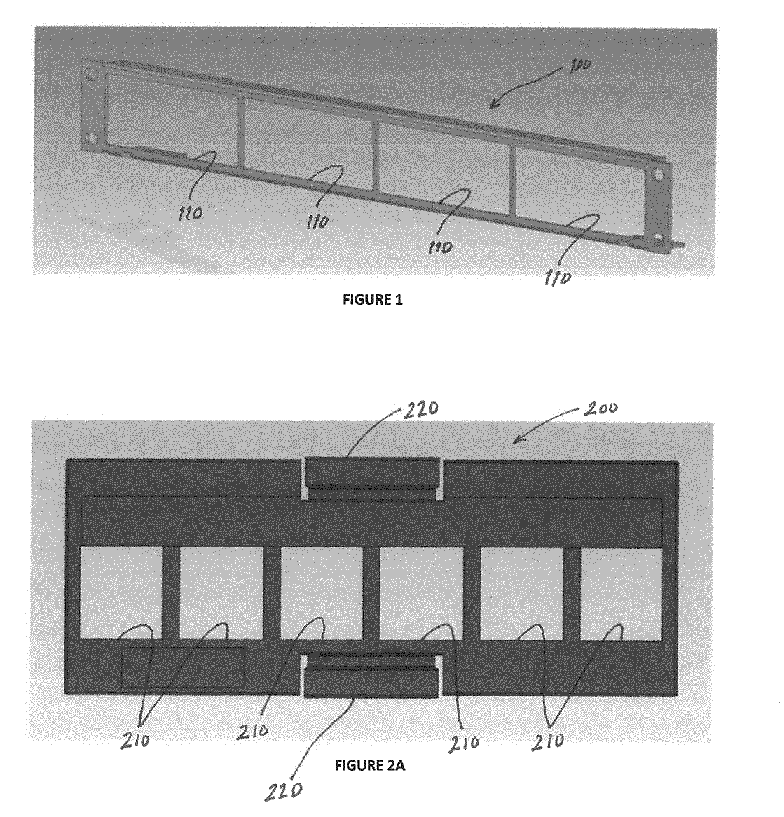

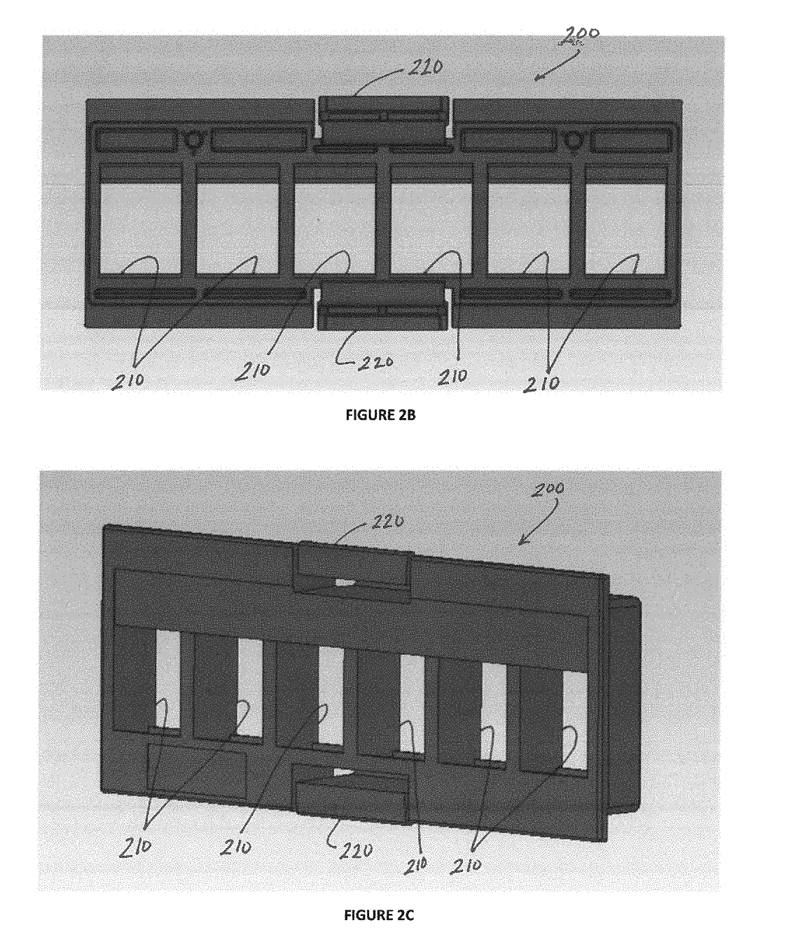

Referring initially to FIG. 1, a metal mounting panel 100 is illustrated. The metal mounting panel 100 includes four large cutouts 110 for accommodating various connectors using an intermediate modular adapter 200 (shown in FIGS. 2A-2C). Each intermediate modular adapter 200 has multiple openings sized and configured for accommodating multiple connectors.

FIGS. 2A, 2B and 2C respectively illustrate front, rear and perspective views of a plastic intermediate modular adapter 200 in accordance with one nonlimiting embedment. There are six openings 210 designed to mount six corresponding KMJ style connectors on the plastic intermediate modular adapter 200. In the middle of the adapter 200, there are two latches 220, one approximate the top and the other approximate the bottom, which are utilized to mount the plastic intermediate modular adapter 200 on the metal mounting panel 100. Other configurations of the plastic intermediate modular adapter 200 are available for various types of connectors.

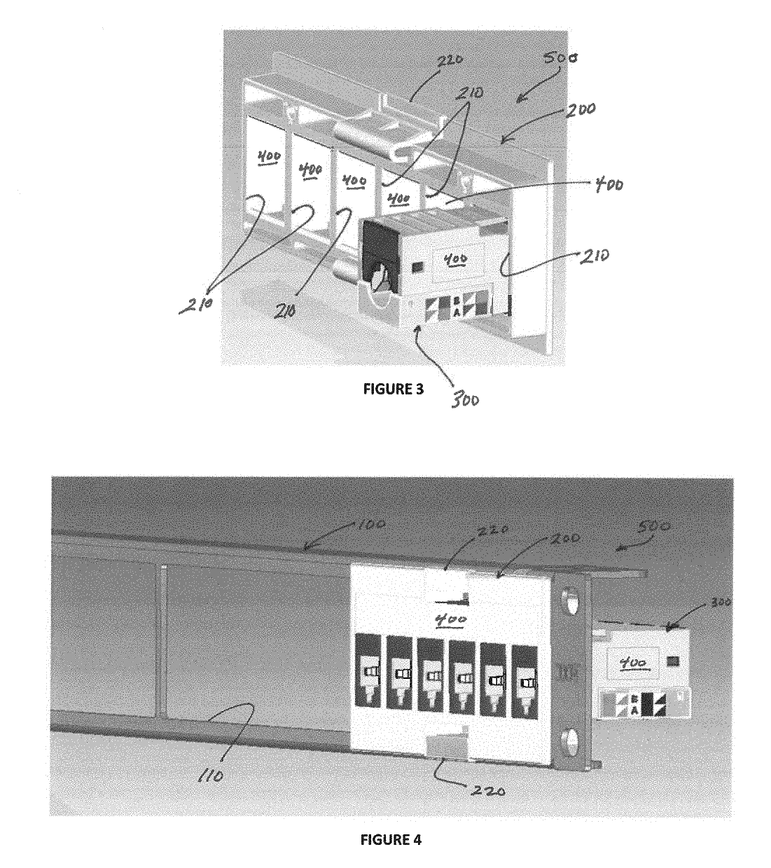

Referring to FIG. 3, a connector 300 is inserted into one opening 210 of the plastic intermediate modular adapter 200. The plastic intermediate modular adapter 200 is plated all around its outer surface, wherein the plated plastic 400 is on the top side of the adapter 200. The connector 300 is also plated on its outside surface, wherein the plated plastic 500 is on the top side of the connector 300. When the connector 300 is inserted within one opening 210 of the plastic intermediate modular adapter 200, the plated plastic on the outer surface of the connector 300 and the plated plastic of the inner surface of the opening 210 are electrically connected. Thus, the connector 300 and the plastic intermediate modular adapter 200 are electrically integrated into a conductive assembly 500. Similarly, more connectors 300 can be inserted into additional openings 210.

Referring now to FIG. 4, one plastic intermediate modular adapter 200 accommodating six connectors 300 is mounted on one cutout 110 of the metal mounting panel 100. As described in FIG. 3, the connections between the plastic intermediate modular adapter 200 and the connectors 300 are through plastic plating. The connections between the plastic intermediate modular adapter 200 and the metal mounting panel 100 are through the direct connection of the plastic plating on the plastic intermediate modular adapter 200 and the unpainted surface of the metal mounting panel 100. As a result, the shielded metallic element in the connector 300 directly connects with the plastic intermediate modular adapter 200 into a conductive assembly 500. Such a conductive assembly 500 is mounted on the metal mounting panel 100 and directly connects with the unpainted surfaces on the metal mounting panel 100 and then with a panel frame that is connected to the ground structure. The grounding connection is completed from the connector 300 to the metal mounting panel 100 through a plastic intermediate modular adapter 200.

The plated adapter could also be designed for use in conjunction with unshielded style connectors as a means of mitigating alien crosstalk between connectors, which is a growing concern with all category levels of data adapters since the introduction of the IEEE 802.3bz standard. This standard describes Ethernet data rates of 2.5 and 5 Gb/s over installed infrastructure. The plated modular adapter would allow end users to replace only the panel portion of the data channel, while allowing them to use currently installed connectors in the event that the alien crosstalk of the channel does not meet the requirements of the 802.3bz standard.

From the foregoing description of various embodiments of the invention, it will be apparent that many modifications may be made therein. It is understood that these embodiments of the invention are exemplifications of the invention only and that the invention is not limited thereto.

What is claimed is:

1. An electrically conductive assembly comprising:
a connector;
a rack mount panel including a plurality of integrally formed cutouts, the rack mount panel being formed from an electrically conductive material;
an intermediate modular adapter that is sized and configured for selective engaged receipt within a corresponding one of the plurality of integrally formed cutouts; the intermediate modular adapter including a plurality of integrally formed openings each being sized for engaged receipt of the connector; the intermediate modular adapter being plated with an electrically conductive material; and
wherein selective engagement of the connector in one of the plurality of integrally formed openings on the intermediate modular adapter creates an electrical connection between the connector, the rack mount panel, and the intermediate modular adapter.

2. The electrically conductive assembly as recited in claim 1 wherein the connector includes a shield element.

3. The electrically conductive assembly as recited in claim 2 wherein a grounding connection is established between the shield element and the rack mount panel.

4. The electrically conductive assembly as recited in claim 1 wherein the intermediate modular adapter is formed from plastic.

5. The electrically conductive assembly as recited in claim 1 wherein the rack mount panel is formed from metal.

6. The electrically conductive assembly as recited in claim 1 wherein the connector is a six-port data module.

7. The electrically conductive assembly as recited in claim 1 wherein the connector is a KMJ style connector.

8. An electrically conductive assembly for grounding a connector shield element to a rack mounted panel, the electrically conductive assembly comprising:
a connector including the connector shield element;
the rack mount panel including a plurality of integrally formed cutouts, the rack mount panel being formed from an electrically conductive material;
an intermediate modular adapter that is sized and configured for selective engaged receipt within a corresponding one of the plurality of integrally formed cutouts; the intermediate modular adapter including a plurality of integrally formed openings each being sized for engaged receipt of the connector; the intermediate modular adapter being plated with an electrically conductive material; and
wherein selective engagement of the connector in one of the plurality of integrally formed openings on the intermediate modular adapter creates an electrical connection between the connector, the rack mount panel, and the intermediate modular adapter.

9. The electrically conductive assembly as recited in claim 8 wherein the intermediate modular adapter is formed from plastic.

10. The electrically conductive assembly as recited in claim 8 wherein the rack mount panel is formed from metal.

11. The electrically conductive assembly as recited in claim 8 wherein the connector is a six-port data module.

12. The electrically conductive assembly as recited in claim 8 wherein the connector is a KMJ style connector.

13. An electrically conductive assembly for grounding a connector shield element to a rack mounted panel, the electrically conductive assembly comprising:
a connector including the connector shield element;
the rack mount panel including a plurality of integrally formed cutouts, the rack mount panel being formed from an electrically conductive material;
an intermediate modular adapter being formed from plastic that is sized and configured for selective engaged receipt within a corresponding one of the plurality of integrally formed cutouts; the intermediate modular adapter including a plurality of integrally formed openings each being sized for engaged receipt of the connector; the intermediate modular adapter being plated with an electrically conductive material; and
wherein selective engagement of the connector in one of the plurality of integrally formed openings on the intermediate modular adapter creates an electrical connection between the connector, the rack mount panel, and the intermediate modular adapter.

14. The electrically conductive assembly as recited in claim 13 wherein the rack mount panel is formed from metal.

15. The electrically conductive assembly as recited in claim 13 wherein the connector is a six-port data module.

16. The electrically conductive assembly as recited in claim 13 wherein the connector is a KMJ style connector.
